(19) United States
(12) Patent Application Publication
(10) Pub. No.: US 2014/0092381 A1
(43) Pub. Date: Apr. 3, 2014

(54) PORTABLE OPTICAL FIBER TEST SET CONTROLLABLE THROUGH WIRELESS MOBILE DEVICE

(71) Applicant: Radiantech, Inc., Hsinchu City (TW)

(72) Inventors: Tzu-Tsai CHU, Hsinchu City (TW); Brian P. SUI, Hsinchu City (TW); Hao-Ping SHEN, Hsinchu City (TW); Hsi-Lin CHANG, Hsinchu City (TW)

(73) Assignee: Radiantech, Inc., Hsinchu City (TW)

(21) Appl. No.: 14/042,930

(22) Filed: Oct. 1, 2013

(30) Foreign Application Priority Data
Oct. 2, 2012 (TW) 101219044

(51) Int. Cl. G01M 11/00

(52) U.S. Cl. CPC G01M 11/3145
USPC 356/73.1

(57) ABSTRACT

A portable optical fiber test set controllable through a wireless mobile device includes: a portable optical fiber tester, which has a communication interface and can test an optical fiber; and a wireless mobile device electrically connected to the communication interface, so that the wireless mobile device can control the portable optical fiber tester to test the optical fiber and can upload test results and data, obtained by the portable optical fiber tester, to a cloud through a wireless network or download data from the cloud. The invention utilizes the portable optical fiber tester, which has the communication interface and works in conjunction with a function of the wireless mobile device connecting to the network whenever network is available, so that the invention becomes the portable optical fiber testing device that can be conveniently carried and used.

This application claims priority of No. 101219044 filed in Taiwan R.O.C. on Oct. 2, 2012 under 35 USC 119, the entire content of which is hereby incorporated by reference.

### BACKGROUND OF THE INVENTION

1. Field of the Invention

The invention relates to an optical fiber test set, and more particularly to a portable optical fiber test set controllable through a wireless mobile device, wherein an optical fiber tester with a communication interface is combined with the wireless mobile device.

2. Related Art

Because an optical fiber has the advantages of the high bandwidth, the high data transmission rate and the low signal loss and is free from being affected by the electromagnetic interference, the optical fiber has the significant advantage over other transmission media. Therefore, in the market with the flourishing development of the current network information, the rapid growth of the optical communication has gradually replaced the conventional communication mode using copper wires for transmission.

With the rapid increasing of optical fiber installation, optical fiber testing operation plays an important role to determine the installation and maintenance cost. Optical fiber testers such as an optical power meter, a lost meter and an Optical Time Domain Reflector-meter (OTDR), are valuable tools widely used for the diagnosis of optical fibers. These optical fiber testing functions are selectively built in a test set for quality check after fiber installation, everyday monitoring of installed fibers and used during the repair of optical fiber as fiber fault.

Traditionally, optical fiber test set are designed as a standalone instrument. All the functionalities are built into the enclosure of the instrument. Apart from the basic optical fiber testing functions, a test set also need to provide general functions such as operation interface, display, data collection, data analysis (computation) and data storage in the enclosure of the tester. At least two major weak point of the standalone optical fiber test set are addressed in view of this invention. The standalone test sets are built with general functions which can be provided with a common wireless mobile device. The function extra to the optical fiber testing function require extra cost, extra maintenance load to the manufacturer, and require extra size and weight to the test set. A modern wireless mobile device provides much better performance and operation experience for those general functions. In addition to the normally required general functions of a test set, wireless mobile device provide wireless data communication function that is not commonly available with a standalone optical fiber test set. With the wireless function, an optical test set is opened with many possibilities, which will be especially useful for heavy duty optical fiber field testing.

### SUMMARY OF THE INVENTION

A main object of the invention is to provide a portable optical fiber test set, designed with focus only on the necessary optical fiber test functions. The commonly required general functions such as user interface, display, computation and data storage are removed from the optical fiber tester. A commonly available wireless mobile device, with software accompany the optical fiber tester installed, is used to fulfill the need for those common functions. The operation of the optical fiber tester is controlled by the wireless mobile device with a data communication interface.

The optical fiber tester is designed with optical testing functionalities of the combination including but not limited to an optical power meter, an optical loss meter, and an OTDR. It is designed with at least one type of industrial standard data communication interface such as Universal Serial Bus (USB), or Serial Advanced Technology Attachment (SATA).

The wireless mobile device is a commonly available wireless mobile device. It can be a smart phone, a tablet computer, a notebook computer or a Personal Data Assistant (PDA), with a suitable computing power and equipped with proper user interface and with at least one type of industrial standard data communication interface such as USB, or SATA to match the communication interface of the optical fiber tester.

The accompany software to the optical fiber tester should provide the function to control the optical fiber tester, collect data from the optical fiber tester, process the data, analyze the data and provide display for the operation interface, data plot and analysis result.

The benefit of the invention are, (a) The reduction of development cost and maintenance cost, the reduction of weight, size, and power consumption. All by leveraging the commonly available technology. (b) Extra wireless connection provided by nowadays common wireless mobile device give rise many possibilities such as real time data synchronization between just acquired field data and Head Quarter (HQ) data, HQ expert assisted operation, debugging to the tester in the field, current data comparison to history data and remote data analysis.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a portable optical fiber testing device of the invention.

FIG. 2 is a schematic block diagram showing a portable optical time domain reflectometer (OTDR) according to an embodiment of the invention.

FIG. 3 is a schematic illustration showing a connection state when the invention is actually performing the optical fiber diagnosis.

### DETAILED DESCRIPTION OF THE INVENTION

The present invention will be apparent from the following detailed description, which proceeds with reference to the accompanying drawings, wherein the same references relate to the same elements.

In this invention, an optical fiber tester having a communication interface, and a wireless mobile device having an Internet access function are combined. Thus, the wireless mobile device can be directly connected to and control the optical fiber tester to test an optical fiber, and can upload the data, measured in the field, or download data through the network whenever network connectivity is available.

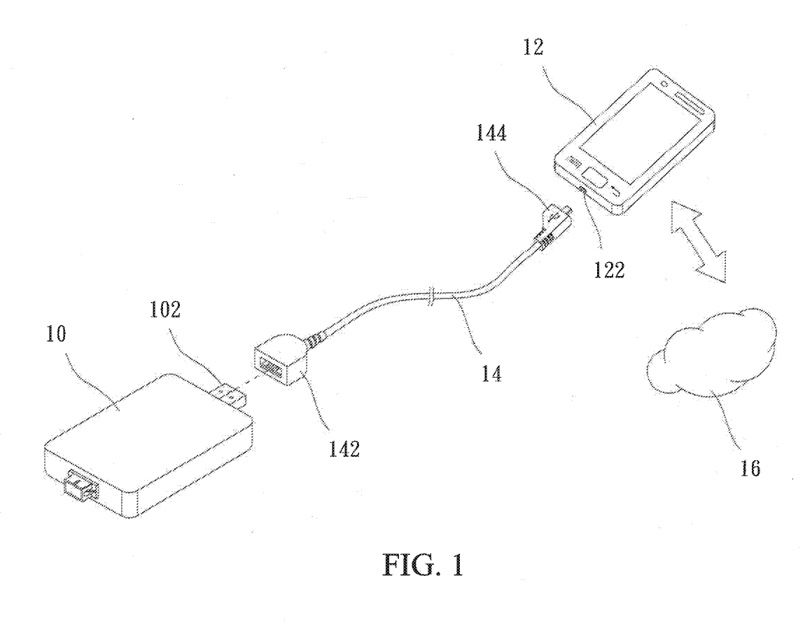

Referring to FIG. 1, the portable optical fiber test set of the invention mainly includes two parts. The first part is a portable optical fiber tester 10, such as an OTDR, a loss tester or an optical power meter. The second part is a wireless mobile device 12, such as a smart mobile phone, a notebook computer, a tablet computer, a personal digital assistant (PDA) or the like, wherein the wireless mobile device depicted in the drawing is a most common smart mobile phone serving as an example. This wireless mobile device 12 is installed with the control software corresponding to the portable optical fiber tester 10 and the software for the cloud transmission and analysis. The portable optical fiber tester 10 has a communication interface (102), which may be universal serial bus (USB) or a serial advanced technology attachment (SATA). In the drawing of this embodiment, a USB connector 102 is illustrated as an example. The portable optical fiber tester 10 may be connected to an optical fiber to test the optical fiber. The wireless mobile device 12 is electrically connected to the USB connector 102 of the portable optical fiber tester 10 through a cable 14. The cable 14 has one end being a USB port 142 matching with the USB connector 102 (or being a SATA connector), and the other end being a connector head 144 provided in correspondence with a connection port 122 of the wireless mobile device 12. In the drawing of this embodiment, a mini-USB connector plug is illustrated as an example. The wireless mobile device 12 is connected to and controls and receive test data from the portable optical fiber tester 10 through the cable 14, and can upload the test results to a cloud 16 through a wireless network, or download the data from the cloud 16 through the wireless network. The wireless network may be an Internet or a mobile communication network. In addition, the cloud 16 mentioned herein includes cloud computing services, in which the services are obtained remotely through the network connection, or cloud computing technologies providing various computations. On the cloud 16, more complicated calculating and analyzing computations may be performed on the data uploaded to the cloud 16, and the results are returned to and displayed on the wireless mobile device 12 on the measurement site so that the processing on site may be performed.

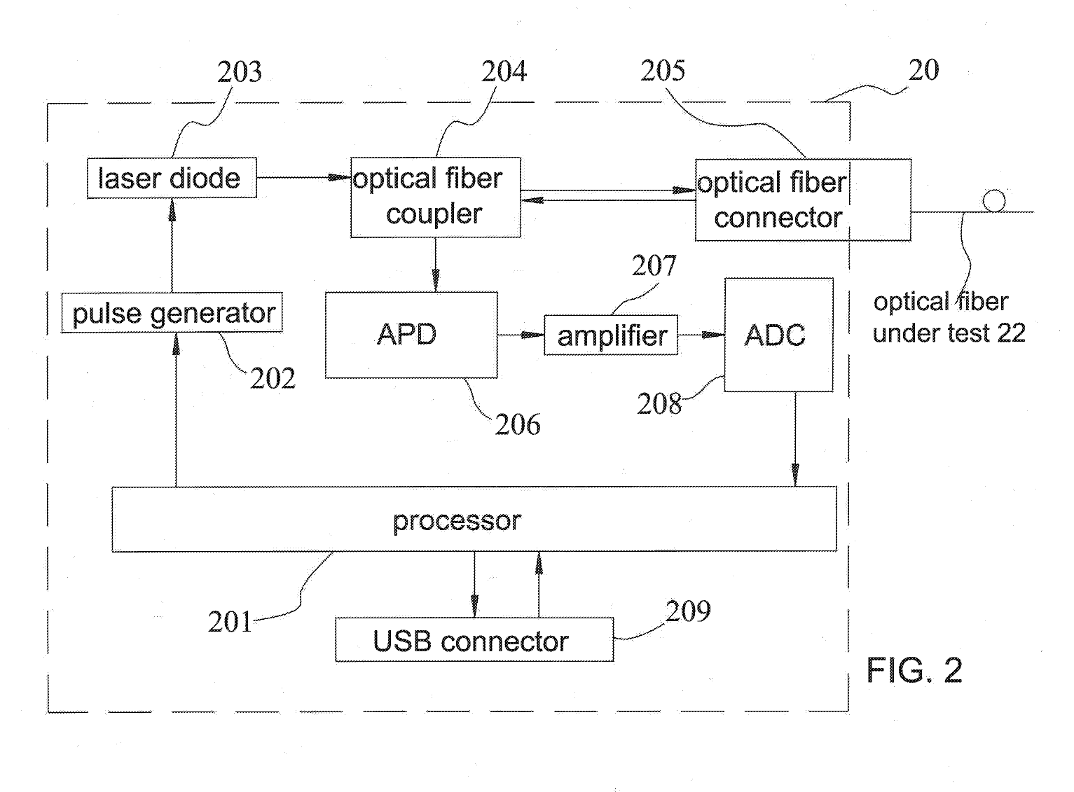

After the overall architecture of the invention has been described, the portable optical fiber tester 10 according to one embodiment of the invention will be described. Herein, a portable OTDR 20 serves as an example. Referring to FIG. 2, the portable OTDR 20 includes a processor 201, a pulse generator 202, a laser diode 203, an optical fiber coupler 204, an optical fiber connector 205, an Avalanche Photo Diode (APD) 206, an amplifier 207, an Analog to Digital Converter (ADC) 208 and a USB connector 209. The processor 201 send control signal to the pulse generator 202 to drive the laser diode 203 to deliver an optical test pulse. Optical test pulse is transferred through the optical fiber coupler 204, to an optical fiber under test (hereinafter referred to as OFUD) 22 connected to the connector 205. The returned optical signal is received by the APD 206 through the optical fiber connector 205 and the optical fiber coupler 204. The APD convert the returned optical signal to photo current. The photo current is amplified by the amplifier 207 and sampled and digitized by the ADC 208. The data from the ADC is collected and arranged by processor 201. then send to USB interface 209 for the outside wireless mobile device, referring to FIGS. 2 and 1. Once data are collected by the wireless mobile device. The display, analysis, storage of data is under the control of the accompany software installed in the wireless mobile device according to the instruction of the testing operator.

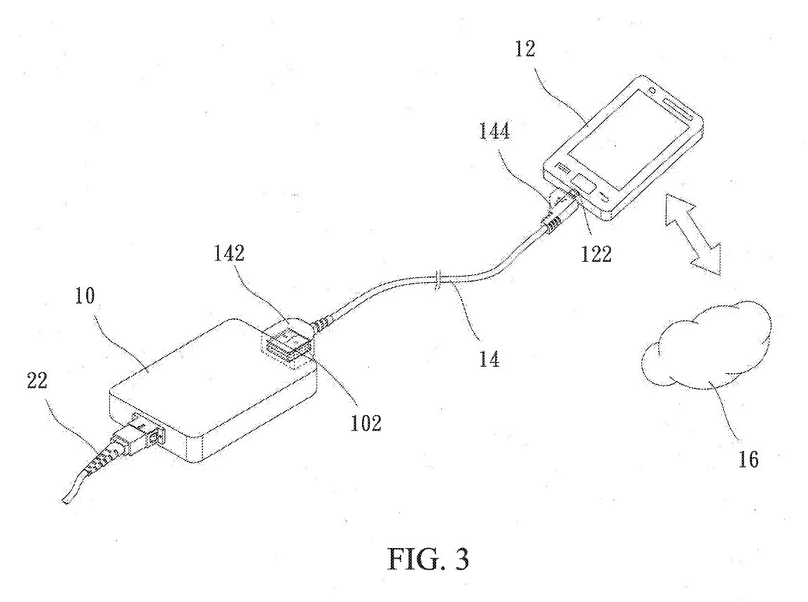

When the portable optical fiber set of the invention is used to perform the test, as shown in FIG. 3, the USB connector 102 of the portable optical fiber tester 10 is inserted into and connected to the USB socket 142 of the cable 14, and the connector plug 144 on the other end of the cable 14 is correspondingly inserted into and connected to the socket 122 of the wireless mobile device 12. Thus, the wireless mobile device 12 is directly connected to and control the portable optical fiber tester 10 through the cable 14, and the portable optical fiber tester 10 is connected to the OFUD 22. As a result, the wireless mobile device 12 can control the portable optical fiber testing device 10 and able to gather test data, and can upload the test results and data, obtained or collected on site, to the cloud through the wireless network connected to the wireless mobile device, or download the data from the cloud through the wireless network.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A portable optical fiber test set controllable through a wireless mobile device, the test set comprising:
a portable optical fiber tester which has a communication interface and can test an optical fiber; and
a wireless mobile device, which has corresponding the communication interface to the portable optical fiber tester and is installed with an accompany control software of the portable optical fiber tester;
the accompany software, which can perform the control functions to control the optical fiber tester when the optical fiber tester is connected to the wireless mobile device; the control functions include an operation, a data collection, a data analysis data display and an analysis result display.

2. The device according to claim 1, wherein the portable optical fiber tester is built with the combination of a following optical testing function, an optical time domain reflecto-meter (OTDR), a loss tester or an optical power meter.

3. The device according to claim 1, wherein the communication interface is a universal serial bus (USB) or a serial advanced technology attachment (SATA) connector,

4. The device according to claim 1, wherein the wireless mobile device is a smart mobile phone, a notebook computer, a tablet computer or a personal digital assistant (PDA).

5. The device according to claim 1, wherein the wireless mobile device further upload and downloads data from a cloud using the wireless network.

6. The device according to claim 5, wherein the wireless network is Internet or a mobile communication network.

7. The device according to claim 6, wherein the cloud can perform cloud computing services or cloud computing technologies.

8. The device according to claim 7, wherein the cloud can further calculate and analyze the data, and return results to the wireless mobile device in the field.
